(19) United States
(12) Patent Application Publication
(10) Pub. No.: US 2004/0073629 A1
(43) Pub. Date: Apr. 15, 2004

(54) Method of accessing internet resources through a proxy with improved security

(75) Inventors: Philippe Bazot, Vence (FR); Fabrice Livigni, Mougins (FR)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/677,467

(22) Filed: Oct. 2, 2003

(30) Foreign Application Priority Data
Oct. 10, 2002 (EP) 02368110.9

(51) Int. Cl. G06F 15/16

(52) U.S. Cl. 709/217

(57) ABSTRACT

Method of accessing Internet resources provided by at least a content server in a data transmission system including a proxy connected to an Internet network, the proxy being provided with authentication means for authenticating a user when receiving a request for Internet resources therefrom, and wherein the proxy transmits the user request to the content server which sends back a response to the proxy together with at least one cookie containing information about the user's session. The proxy receiving the response with the cookie stores the cookie in a user context database and transmits this response to the user after the cookie(s) has (have) been removed from the response, so that the user can send all requests for accessing the Internet resources contained in the content server to the proxy.

### BACKGROUND OF THE INVENTION

1. Technical Field

The present invention relates to the Internet environment wherein a user addresses requests for Internet resources to a proxy which transmits these requests to a content server able to provide the Internet resources and relates in particular to a method of accessing Internet resources through a proxy with improved security.

2. Description of the Related Art

The Service Provider market has moved up the value chain from pure connectivity services to deliver value-added and revenue generating services. The business model of a Service Provider was initially driven by minutes of use and is being increasingly replaced by data traffic generated by users that access external services, typically not maintained by the Service Provider itself but accessed through the Service Provider platform. The Service Provider plays a key role since it is the intermediary between the Subscriber and the external services. Its privileged position allows the Service Provider to not only provide just “simple” access but added value services such as security, single sign-on, billing, location, etc. at the condition that it cannot be “bypassed” by the user.

In the World Wide Web context where the device being used to access the external Web Services is typically a Web browser, this is usually done through the use of a proxy component, a “Web Proxy,” placed in the service provider platform. When the proxy is a forward proxy, the Web browser is forced to go through the Web proxy by configuration.

When a client program establishes a connection “through” a proxy to a destination content server, it first establishes a connection directly to the proxy server program. The client then negotiates with the proxy server to make the proxy establish a connection on behalf of the client between the proxy and the destination content server. If successful, there are then two connections in place: one between the client and the proxy server and another between the proxy server and the destination content server. Once established, the proxy then receives and forwards traffic bi-directionally between the client and the remote content server. The proxy makes all connection-establishment and packet-forwarding decisions.

A proxy can be configured as “reverse proxy” in order to add more security and to protect in an efficient way the back-end Web services. In such a case, the proxy appears to the client to be the destination content server. To the content server, the reverse proxy server acts as the originator of client requests. If a client wants to access a file, for example main.html, he/she points its browser to the reverse proxy, www.DomainA.com believing this is the Internet address of the content server. The reverse proxy server will accept the client request for main.html, retrieves the requested page from the content server residing on w3.DomainB.com, and returns it to the client.

Today, many Web Services use a mechanism called a “cookie” to maintain session with the user. Cookies constitute a general mechanism which server side connections can use to both store and retrieve information on the client side of the connection. The addition of a simple, persistent client-side state significantly extends the capabilities of Web based client/server applications. When returning an HTTP object to a client, the server also sends a cookie that the client will store. Included in such a cookie is domain information indicating in which domain the cookie is valid. Any future HTTP requests made by the client which fall in that range will include a transmittal of the current value of the cookie. Although the cookies have become an essential object of every Web connection between a client and a content server, they present an important drawback; the cookies contain sensitive information that could be potentially used for hacking purposes if they can be received and analyzed by the users themselves.

### SUMMARY OF THE INVENTION

Accordingly, one object of the invention is to achieve a method of accessing Internet resources through a proxy which keeps the cookies on the service provider platform at the disposal of the proxy thus preventing these cookies from being downloaded and potentially analyzed by the user or a hacker taking the place of the user.

The invention relates therefore to a method of accessing Internet resources provided by at least a content server in a data transmission system including a proxy connected to an Internet network, the proxy being provided with authentication means for authenticating a user when receiving a request for Internet resources therefrom, and wherein the proxy transmits the user request to the content server which sends back a response to the proxy together with at least one cookie containing information about the user's session. The proxy receiving the response with the cookie stores the cookie in a user context database and transmits this response to the user after the cookie(s) has (have) been removed from the response, so that the user can send all requests for accessing the Internet resources contained in the content server to the proxy.

### BRIEF DESCRIPTION OF THE DRAWINGS

The above and other objects, features and advantages of the invention will be better understood by reading the following more particular description of the invention in conjunction with the accompanying drawings wherein:

FIG. 1 is a schematic block-diagram showing a data transmission system implementing the method according to the invention, and

FIG. 2 is a flow chart of the method of accessing Internet resources through a proxy according to the invention.

### DETAILED DESCRIPTION OF THE INVENTION

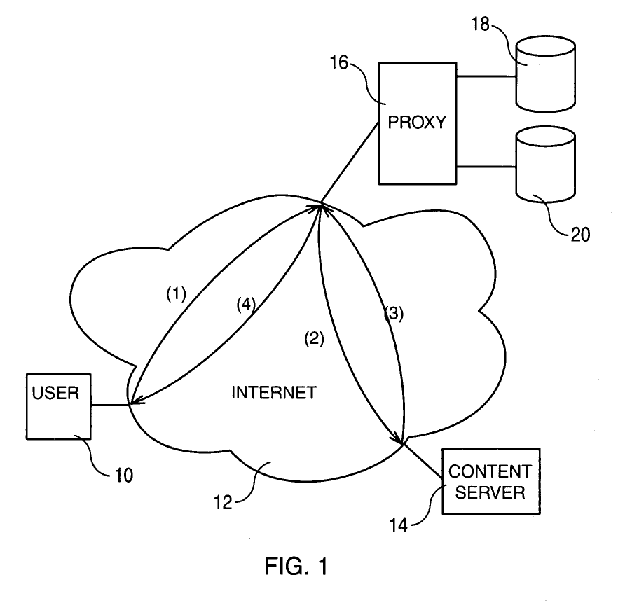

Referring to FIG. 1 representing a data transmission system used in the context of the invention, a service provider provides Web services to a plurality of users such as user 10 through an Internet network 12. Such web services can be any kind of information which can be furnished by a content server 14. When the user wants to access the content server 14, he/she transmits a request to a proxy 16. The proxy 16 has at its disposal a user registry 18 containing information such as credentials of the users allowed to access the services provided by the service provider (generally the identification and password of the user). It has also a user context database 20 for each user 10 wherein are stored the session cookies associated with the user 10 as explained hereunder.

As already mentioned, the user's Web browser first establishes a connection (1) directly to the proxy 16. Then, the proxy 16 establishes a connection (2) on behalf of user 10 between proxy 16 and content server 14. Once established, the proxy 16 receives a (3) Web response from the content server 14 and forwards these pages (4) to the user 10.

It must be noted that a session cookie is automatically resent to the content server when the user requests an URL from this server. In other words, the cookies are automatically replayed for the content server whose the Internet Domain matches the full domain name of the server that provided the page which created the cookie (or cookies) and if they were defined as valid across this domain. Note that, by default, if the domain is not specified, a cookie is valid only for the content server which set it before. It is possible that a small portion of the domain name shares cookies among several servers sharing a top-level domain. For instance, the cookies for the “domain A.com” will be resent automatically for the servers included in the “domainA.com” but will be also resent for all sub-domain such as “domainAA.domain A.com.”.

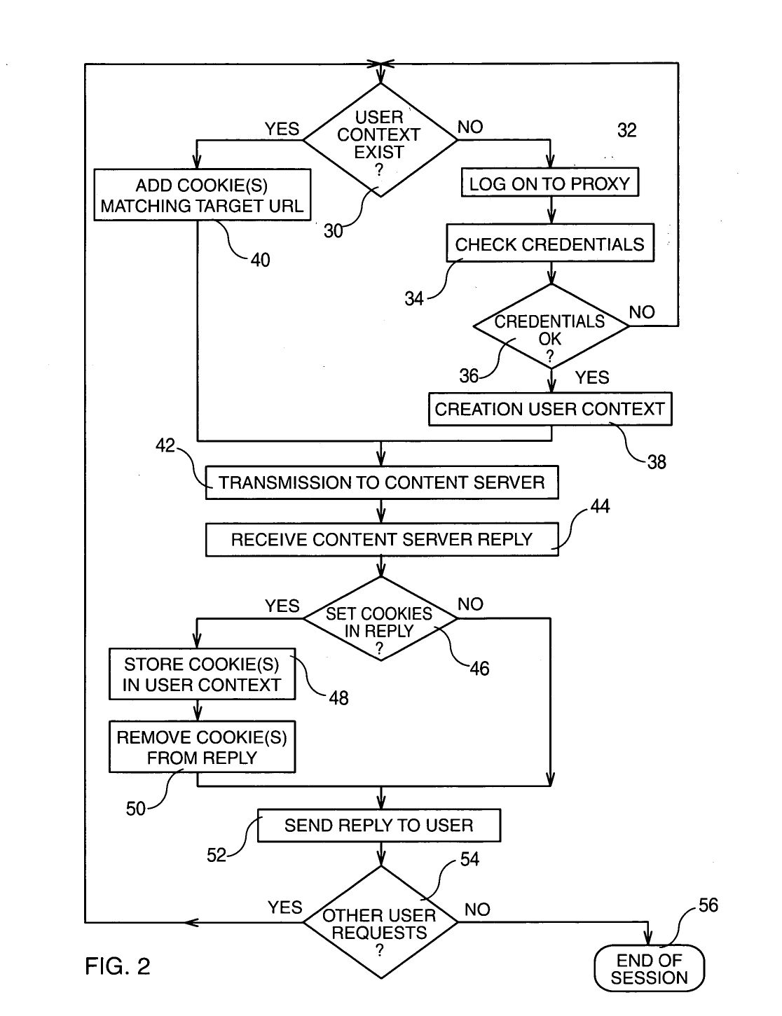

The steps of the method according to the invention are now described in reference to FIG. 2 wherein the proxy device is a reverse proxy. First, it is determined whether a user context exists when the user 10 gains access to the proxy 16 (step 30). If not, the user 10 logs on to the proxy 16 to access an URL in content server 14, for example the address “w.w.w.domainA.com/serviceB” (step 32). The proxy 16 checks the credentials sent by the user 10, either in a form or in the header of the request such as the HTTP header in the user registry 18 (step 34). It is then determined whether the credentials are OK (step 36). If not, the process loops back to the first step. When the credentials are found OK, the proxy 16 creates a user context for the user 10 in the user context database 20 (step 38). Note that, when a user context already exists in the proxy 16, the request is automatically recognized and mapped by the proxy 16 as a protected URL (it checks if the user 10 has been already authenticated thanks to the presence or not in the user context database 20 of an associated record) that needs to be forwarded to the content server 14. This implies that all different URLs which access “service B” are defined and mapped in the proxy configuration, such as the address w.w.w.domainA.com/serviceB being mapped with the address w.w.w.domainB.Com. One or more cookies matching the target URL are then added to the request (step 40).

After the user context has been created in the proxy 16 or if it already exists, the request is transmitted by the proxy 16 to the content server 14 with the address w.w.w.domainB.com (step 42). The content server 14 answers back to the proxy 16 with the information requested by the user 10 (step 44). Note that, for various reasons, the content server 14 receiving the request generally needs to track the user session with a unique session ID or with other suitable mechanisms.

At this stage, the proxy 16 determines whether one or more cookies have been set in the reply sent by the content server 14 (step 46) by checking the statement “set-cookies.” When received by the proxy 16, the cookies are stored in an associated record in the user context database 20 (step 48). The cookies are stored with the associated targeted Internet domain (“domainB.com”) of the content server 14 or with the full content server name (“www.domainB.com”) if the domain is not specified, in order to be able to send it again for all HTTP sub-requests. Once the cookies are stored, the statement “set-cookies” is removed from the HTTP response (step 50). This hides the value of the cookie from the user 10, thereby adding more security to the system.

Then, the HTTP reply is sent back to the user browser without any cookies referencing the content server 14 (step 52). It is then checked whether there are other user requests to same content server 14 (step 54). If not, the session is ended (step 56). When there are other subsequent requests to the same URL, the process loops backs to the beginning (step 30).

Although the method according to the invention can be applied with a forward proxy, it is preferable to use a proxy 16 configured as a reverse proxy. However, without the invention, there is problem if the content server 14 is not in the same Internet domain as the proxy. In such a case, the user 10 should receive an answer from the content server 14 with a cookie valid for the domain to which the content server 14 belongs (e.g. domainB.com) but invalid for his own domain (e.g.domainA.com) . Since the name of the content server 14 is for the user's browser a name of its domain (domainA.com) the cookie will not be sent to the proxy 16 for subsequent sub-requests to the same URL. Therefore, the session will not be maintained.

Conversely, if the method according to the invention is used with a reverse proxy, the reverse proxy receives the cookie in the domain of the content server 14 (e.g. domainB.com) and stores it into the user context database 20. When subsequent sub-requests to the same URL are sent to the reverse proxy, the latter retrieves the cookie to be sent to the content server 14 in as much as it establishes a correspondence between the URL seen by the user's browser in a first domain (e.g. domainA.com) and the true name of the server in a second domain (e.g. domainB.com). In such a case, the session will be maintained.

1. Method of accessing Internet resources provided by at least a content server in a data transmission system including a proxy connected to an Internet network, said proxy being provided with authentication means for authenticating a user when receiving a request for Internet resources therefrom, and wherein said proxy transmits the user request to said content server which sends back a response to the proxy together with at least one cookie containing information about said user;
said proxy receiving and storing said response in a user context database and transmitting said response to said user after said cookie has been removed from said response, so that said user can send all subsequent requests for accessing said Internet resources contained in said content server to said proxy.

2. Method according to claim 1, wherein said proxy is configured as a reverse proxy establishing a connection to said content server on behalf of said user when receiving said request from said user, and wherein said cookie is transmitted by said reverse proxy to said content server when said user sends other requests for a same URL even if said content server does not belong to a same domain as said reverse proxy.

3. Method according to claim 1, wherein said cookie which has been stored in said user context database is added to all subsequent requests from said user for accessing Internet resources in said content server.

4. Method according to claim 3, wherein the response from said content server to said proxy includes a statement “set-cookies,” said statement being removed from said response before transmitting said response to said user.

5. System comprising means adapted for implementing the method according to claim 1.
